(19) United States
(12) Patent Application Publication
(10) Pub. No.: US 2024/0069237 A1
(43) Pub. Date: Feb. 29, 2024

(54) INFERRING SUBSURFACE KNOWLEDGE FROM SUBSURFACE INFORMATION

(71) Applicant: Landmark Graphics Corporation, Houston, TX (US)

(72) Inventors: Satyan Singh, Abingdon (GB); Fan Jiang, Houston, TX (US); Konstantin Osypov, Houston, TX (US); Julianna Toms, Houston, TX (US)

(21) Appl. No.: 18/305,601

(22) Filed: Apr. 24, 2023

Related U.S. Application Data
(60) Provisional application No. 63/401,535, filed on Aug. 26, 2022.

(51) Int. Cl. G01V 1/48; G01V 1/46

(52) U.S. Cl. CPC G01V 1/48; G01V 1/46

(57) ABSTRACT

A geoscience knowledge system can be obtained, where the geoscience knowledge system can include one or more of publicly available information, industry information, proprietary information, or task specific information. The geoscience knowledge system can be represented as a graph, graph data, network nodes, image data, tokenized data, or textualized data. Subsurface information can be obtained such as from seismic images or other types of sensor data. The subsurface information can be transformed or pre-processed, such as denoising, to make it suitable for use by the geoscience knowledge system. Then subsurface knowledge can be inferred from the subsurface information using the geoscience knowledge system. The subsurface knowledge can provided estimates, approximations, or value of the subterranean formation of interest in order to calculate an economic model parameter, such as a hydrocarbon distribution proximate the subterranean formation of interest.

### CROSS-REFERENCE TO RELATED APPLICATION

This application claims priority to U.S. Provisional Application Ser. No. 63/401,535, filed by Satyan Singh, et al., on Aug. 26, 2022, entitled “METHOD FOR INFERRING SUBSURFACE KNOWLEDGE INFORMATION,” commonly assigned with this application and incorporated herein by reference in its entirety.

### TECHNICAL FIELD

This application is directed, in general, to modeling subsurface geologic information and, more specifically, to utilize machine learning methods to generate subsurface knowledge.

### BACKGROUND

Locating hydrocarbons, such as oil or gas, within the earth and extracting the hydrocarbons can be an expensive and complex process. Energy companies face various decisions, e.g. exploration well drilling, investment in a capital energy project, field development planning, estimating reserves to book with governments, and other decisions. Each of the decisions can be informed by geologic knowledge, geophysical data, e.g. surface seismic, and petrophysical data, e.g., offset well(s) data, such as logs, and vertical seismic profile (VSP). Unfortunately, the information used for making the decisions is unstructured.

The state-of-the-art workflows for assembling all sources of information for assessing key parameters in decision analysis involve tracking uncertainties associated with each step of the workflow, e.g. geologic scenarios to seismic imaging uncertainties to reservoir dynamic model uncertainties to reserves probabilistic estimates. It would be beneficial to provide a structured analysis for this information.

### BRIEF DESCRIPTION

Reference is now made to the following descriptions taken in conjunction with the accompanying drawings, in which:

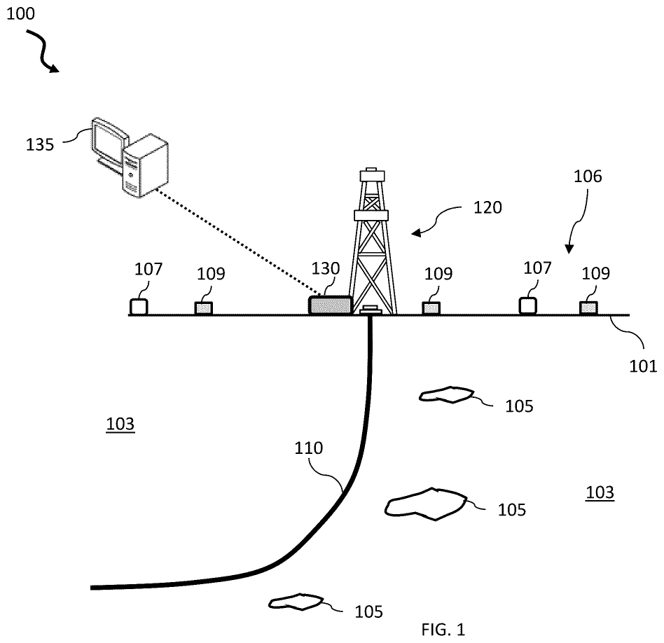

FIG. 1 is an illustration of an example well system;

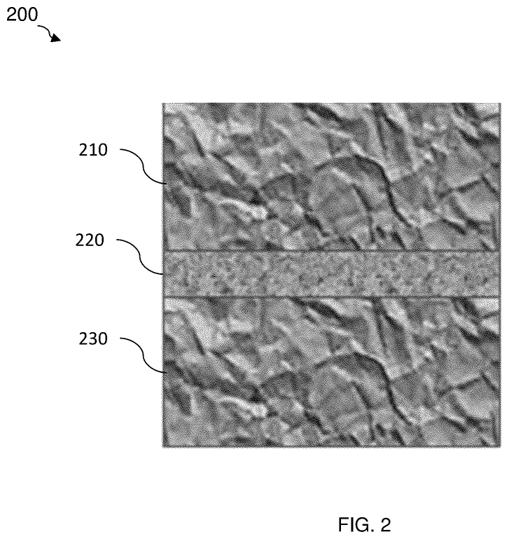

FIG. 2 is an illustration of an example subsurface formation that can be collected via seismic imaging;

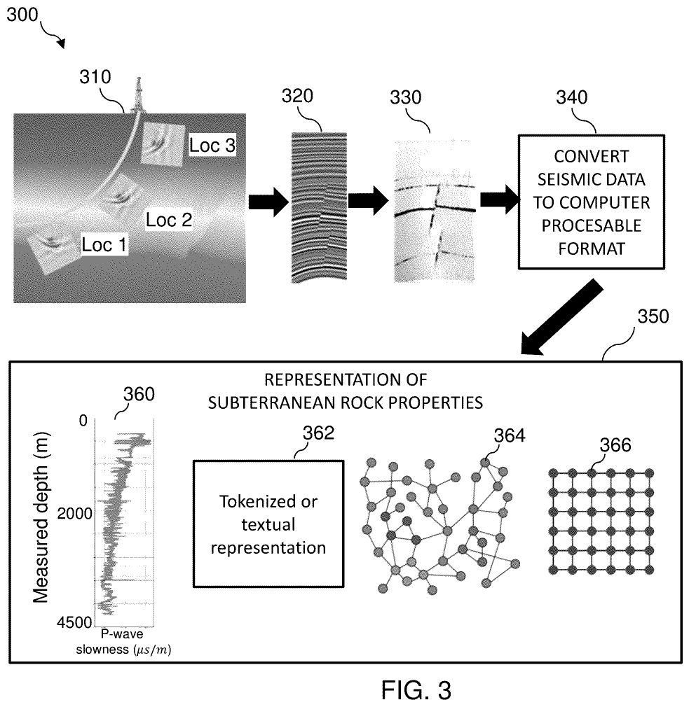

FIG. 3 is an illustration of an example process to obtain subsurface information;

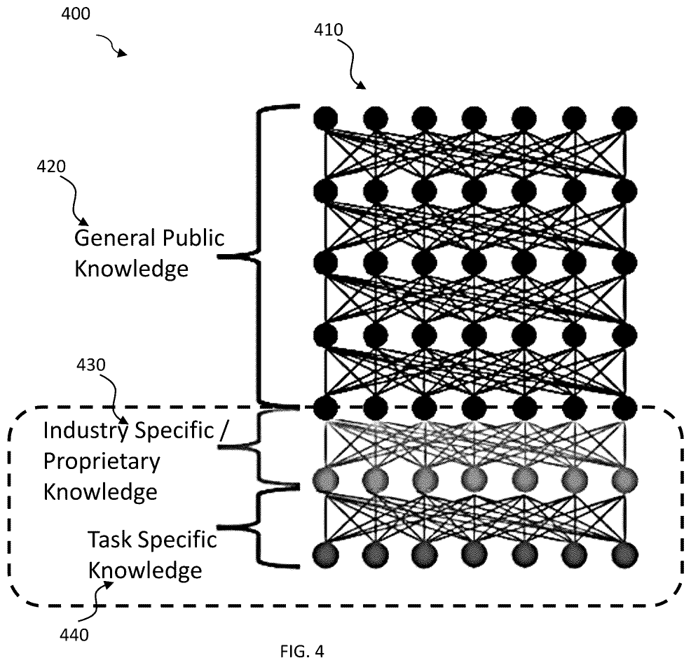

FIG. 4 is an illustration of an example artificial intelligence system used to infer the subsurface knowledge;

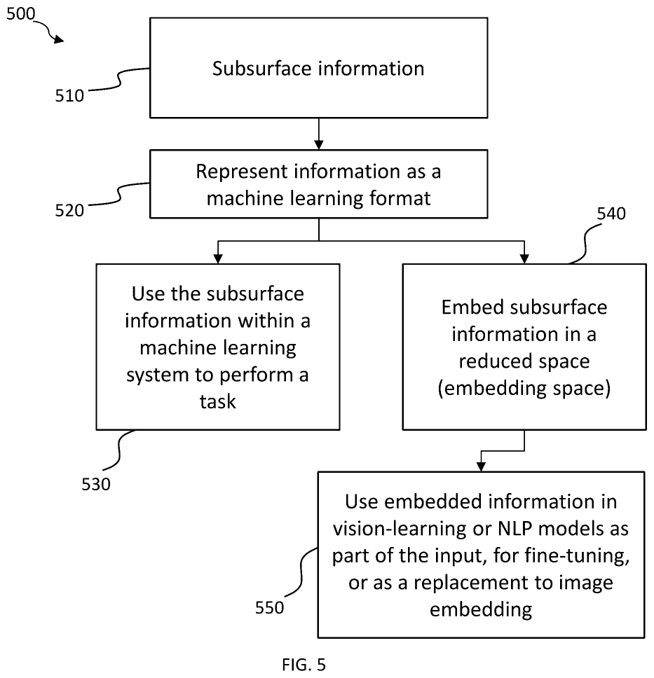

FIG. 5 is an illustration of a flow diagram of an example process of inferring subsurface knowledge;

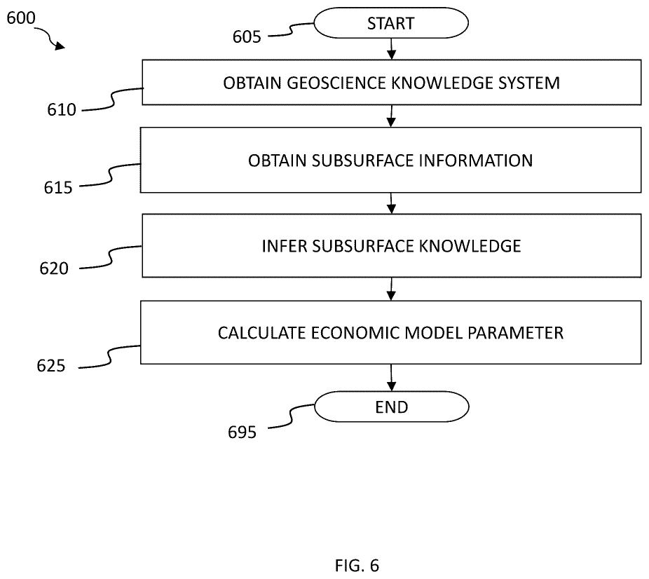

FIG. 6 is an illustration of a flow diagram of an example method to infer subsurface knowledge;

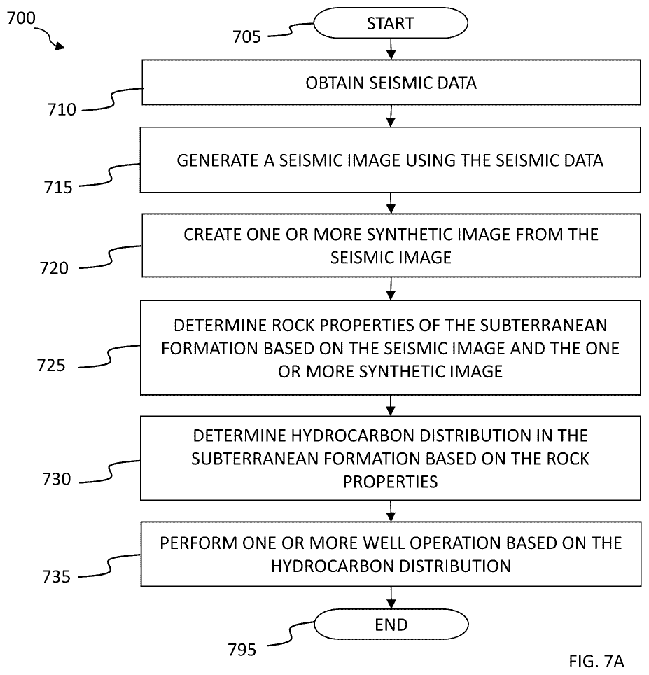

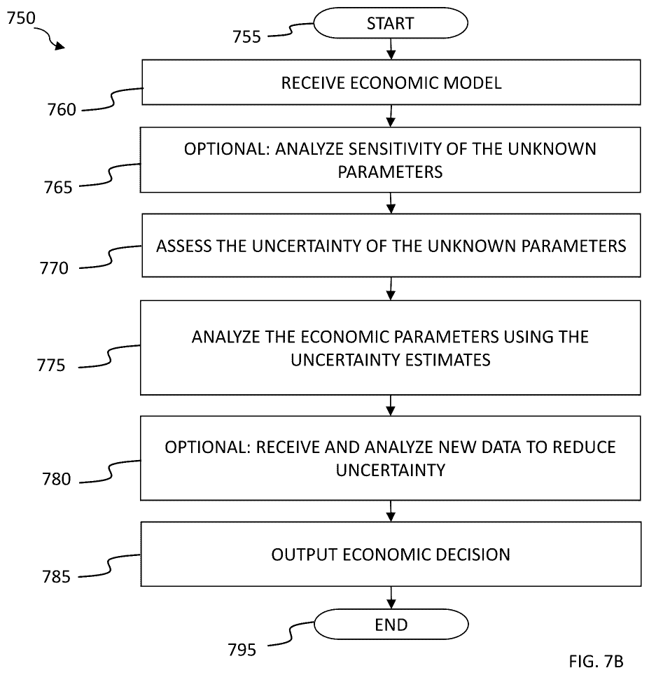

FIG. 7A is an illustration of a flow diagram of an example method using seismic imaging to infer subsurface knowledge;

FIG. 7B is an illustration of a flow diagram of an example method for economic analysis;

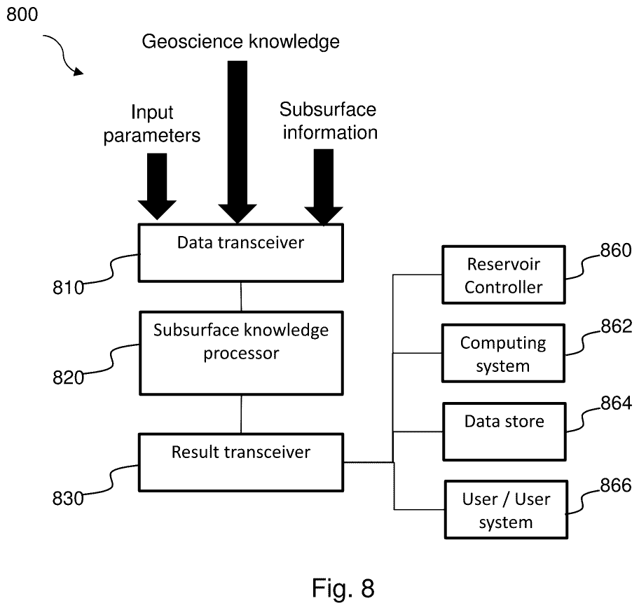

FIG. 8 is an illustration of a block diagram of an example subsurface knowledge system; and

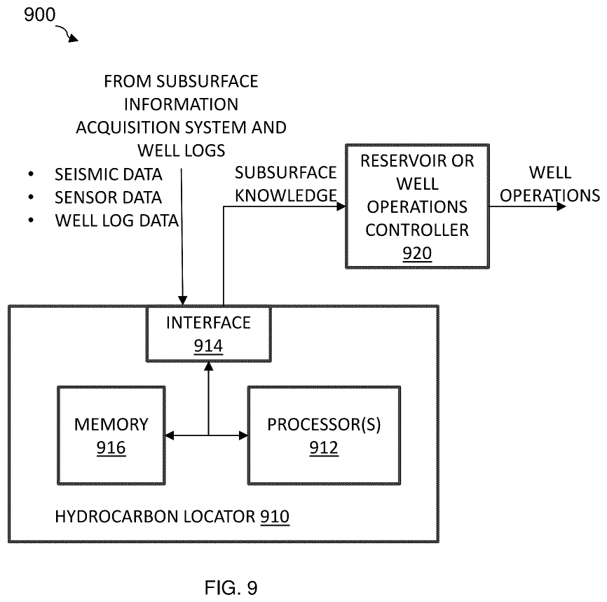

FIG. 9 is an illustration of a block diagram of an example of a subsurface knowledge controller according to the principles of the disclosure.

### DETAILED DESCRIPTION

In determining a course of action or undertaking a task in developing a reservoir or well site, there are many factors to consider. These factors can result in an increase or a decrease in the projected costs of implementing a well system (e.g., economic model parameters). For example, having a high degree of confidence that a hydrocarbon distribution lies at a certain subterranean formation location would be beneficial. It can also be beneficial to know if it is more economical to drill sideways from a more distant location due to the type of rock that lies above the hydrocarbon reservoir. Many other types of factors can be analyzed when determining a placement of a well system or determining an updated task for a well site, such as adjusting a drilling path, or modifying equipment used for future drilling operations. The factors can include subterranean formation characteristics (e.g., rock properties), location of such rocks, how the rock is layered, how the rock is folded, the presence and orientation of fractures or fissures, and other various factors.

These factors form unstructured data that can be collected from one or more sensors or data sources. The sensors can be seismic sensors, nuclear magnetic resonance sensors, acoustic sensors, electrical sensors, gravimetric sensors, and other sensor types. The sensors can be located at the surface, or downhole a borehole. The data sources can be proprietary data sources, such as a corporate database, or public data sources, such as government surveys or public satellite data. This data can be considered subsurface information, e.g., rock properties or subterranean formation characteristics.

Multiple challenges exist in processing the multiple types of unstructured data. For example, a challenge can be the proper analysis of the unstructured multi-disciplinary uncertainties and the proper updating of subsurface knowledge with geophysical data. Subsurface knowledge, for this disclosure, is the inferencing or interpretation of the subsurface information to produce an estimation of what exists at the area of interest in the subterranean formation. For example, knowing a certain combination of rocks exists at a certain depth can be subsurface information. The subsurface information can then be used to generate subsurface knowledge, which can be, for example, having a certain confidence level that that location is easier or harder to drill through or that production ready hydrocarbons are nearby. Understanding the relationships between the different types of data or data points would be beneficial.

Capturing complex relationships in the field of geophysics between data points is not trivial. The concept of representing the neighborhood of information around each data point cannot be represented on a multi-dimensional array in the case where the neighborhood of a data point changes in structure from data point to data point. In other words, the data is unstructured. Because the data is unstructured, the distance between two data points in a multidimensional array cannot be captured. For this disclosure, distance means, for example, the property of the metric being computed. For example, in geophysics, the distance between receivers in an array cannot be represented if the distance between arrays is non-uniform. Conventionally, these distances of neighboring receivers are typically placed in separate storage locations, i.e., the headers.

To represent information, such as the data recording in its natural unstructured form, the disclosure proposes using graphs to capture multi-dimensional unstructured information. In this disclosure, a graph represents relationships between entities such as rocks, subterranean formations, hydrocarbon reservoirs, locations, and other subterranean features. Graphs can apply neural or convolutional network techniques to provide insights when the relationships between entities is as important as the entities' attributes themselves. Information as used herein includes raw data and processed data, which includes, for example, derivatives and interpretations of the data, and knowledge is used as the framework that provides connections between the information components. Data can be used herein as example of information. Graphs can be used for processing of the recorded data, where at least some or all of the information is embedded in the graph. For example, the nodes of the graph can be the receiver recordings, while the edges (connection between nodes) house the relative information between nodes, i.e., their relative distances, offsets, common midpoint locations, and other data elements.

The disclosed processes can provide improvements to conventional processes, for example, by using knowledge graphs to represent the unstructured geophysical data. The connection between the nodes can include categorical or numerical data. Knowledge graphs can be used for processing recorded data. In this aspect, the rich information captured in the knowledge graph can be utilized. In some aspects, an improvement can be learning geology from the latent space of geophysical partial differential equation responses (e.g., neural operators, FNO, paraNet) to geologic models. In some aspects, an improvement can be linking geology knowledge graphs with geophysical data. In some aspects, an improvement can be representing knowledge by quantifying uncertainty for parameters of interest (e.g. normalizing flows, diffusion models, C-Trumpet).

Graphs, i.e., knowledge graphs, can be defined for structural models. This can establish a formal representation framework for structural model knowledge and provide a method to explicitly convey the structural model knowledge to one or more systems or computing systems. A mechanism can be determined to constrain the structural modeling. The spatial topology of geometric objects can be used to determine the framework of the model from a geometric perspective. The structural contact of geologic objects can be used to describe the structure and the relationships contained in the model. A geologic event sequence can be used to describe a history composed of various successive events that create geometric or geologic objects and can define the geologic assemblages. The knowledge graph of the structural models can have one or more types, for example, spatial topology, structural contact, event sequences, other structural models, or a combination thereof.

In some aspects, interpolation of the knowledge graph can be performed. In some aspects, the knowledge graph can be organized such that each node can be a pixel together with other attributes of the data at that point. In some aspects, the edges can be connected to other nodes with the associated relative information, i.e., the relative position in time and space (e.g., x,y, offset y), and azimuth (x,y). In some aspects, the associated relative information can be between the connected nodes and, if the nodes are from the same channel, from the receiver gather and the azimuth. In some aspects, the knowledge graph can include more information between the nodes and edges depending on the application. In some aspects, the edges of the knowledge graph can be dynamic throughout the layers of the network so that missing nodes can be reconstructed when there is suitable information in its neighborhood. In some aspects, the knowledge graph can be built from super gathers to limit the size. Therefore, depending on the computational capabilities, subsets of the data or the entire data set can be analyzed.

In some aspects, the knowledge graph for interpolation does not need to be restricted to neural network interpolation. Other optimization methods for interpolation can be used on the knowledge graph such as minimum weighted norm. In some aspects, interpolation can fill in missing data using the surrounding data, where this can include extrapolation.

In some aspects, the knowledge graph can be used for denoising geophysical data. In some aspects, the full dimensionality of the data can be used to effectively remove noise when it does not exist in a particular dimension or the noise looks different in other dimensions. The noise in this aspect are events that should be removed from the data. In some aspects, a graph neural network can perform better because the noise can manifest itself differently in other domains which the network has access to through the graph.

In some aspects, the knowledge graph can be used in imaging or amplitude variation with offset inversion techniques to extend the imaging algorithm beyond using the receiver gathers to include the angle information or other information to improve the imaging. For example, in imaging the specular and non-specular information can be included in the nodes of the graph while the edges between nodes can be the relative time shift between nodes.

In some aspects, knowledge graphs can make wave propagation more plausible for unstructured recordings instead of attempting to interpolate the recording on a defined grid, which can introduce errors. In some aspects, wave propagation can become grid independent and the need for virtual sources or receivers can be obviated.

In some aspects, knowledge graphs can be used to tie wells to seismic data, for interpreting wells, or for using well logs for geophysical interpretation. This tying can improve on the conventional processes, as it can capture the variation in space and depth (e.g., spatial and depth information) of the different well logs in the area. In some aspects, geologic information can be included in the nodes or edges to better constrain the analyzation (e.g., spatial and a geologic time information).

In some aspects, regularization can be performed using knowledge graphs where traces can be shifted and processed to fit on a grid using the same principle of using the neighborhood of information to reconstruct traces in the required positions.

In some aspects, waveform inversion can be used using knowledge graphs to include well-logs, geology interpretations, and other data as part of the inversion algorithm. In some aspects, the algorithm can be an application using physics-informed neural networks. In some aspects, the knowledge graph can be made sparse or dense depending on the required resolution and guided by the well-logs, geochemistry, cores, and associated interpretations, for example, geologic, structural, or any prior data. In some aspects, graph based inversion can be used such that the nodes are not limited to seismic data, and can utilize well logs, structural information, and other data. In some aspects, the simplest set of edges for such connections can be relative depth based edges, or other physical or empirical relative connection between nodes, for example, prior information or uncertainty.

In one aspect, the data can be ingested in a knowledge database or platform, such as a geoscience learning system, in a format, such as a seismic data format (SEGY) format. For example, the data can be ingested in SeisSpace® computer software and converted to JavaSeis format. The geoscience learning system can acquire subsurface knowledge text, e.g., data, text, or tags that can be used for training subsurface information. In some aspects, a natural language processing (NLP) learning system can be used to capture the subsurface knowledge text from geoscience data, convert the subsurface knowledge text to machine processable data, and to vectorize the machine processable data to use as training labels for the training. The subsurface knowledge text and subsurface images can be acquired from one or more of a geoscience knowledge database, a geoscience document, or a geoscience article.

One or more graphs, such as a knowledge graph, can then be built. Depending on the needed application, nodes of the graph can be assigned to traces (or subsets of traces, or even pixels within a trace) from the JavaSeis dataset. Additionally, edges of the graph can be assigned to represent the neighborhood information and this neighborhood of information can depend on the task. It can be the offset information, distance, categorical information, or other information, between nodes (i.e., the relative information). Large amounts of information, like images on the edges, can be embedded, e.g., compressed.

In some aspects, nodes can include recorded data and other attributes associated to that node. For example, attributes of the recorded data to the node or structural information can be included. Graphs can represent recorded data in its natural form, which can be referred to as a data structure. The knowledge graphs can make it easier to add symmetries within the unstructured framework. For example, reciprocity and time invariance can be included within the graph framework that honors wave propagation.

Graphs of seismic data for event tracking can utilize reinforcement learning. An event (for example, an interface, a horizon, a layer, an arrival) starting point (e.g., seed) can be reached again after a random walk on that horizon. In the case of pre-stack gathers this can work on graphs that include main domains, for example, the graph can include the shot gather or the channel and receiver domains. In some aspects, the data can be mirrored to ensure that the data traces back to the initial starting point after tracking, as this can lead to a maximum reward. Smaller rewards can be achieved by tracking the event with similar dips and shortest distance algorithms, or methods used in conventional tracking applied to the graph.

In some aspects, the learning system can include reinforcement learning where the states are the possible interpretation updates, the background is the input information (e.g., geophysical data or images), the action is the possible interpretations (while providing flexibility for the learning system to explore the state space), and reward being maximized for the final objective. In some aspects, the final objective can be based on the problem posed. In some aspects, the final objective for geophysical data can be the known position of the interpretation (e.g., inference), where the reward is maximized the closer to the known position the learning system gets. In some aspects, the learning system can be updated in subsequent iterations of the process for additional information that is acquired at a later time.

In some aspects, optimal acquisition, i.e., optimize acquisition based on minimizing cost compared to better imaging (understanding) of the subsurface can be utilized. This aspect can generate a graph of the synthetic data. The graph can include the multi-dimensional data so optimizing the data recording parameters can be easier and similar to the actual data acquisition.

Knowledge graphs are currently not the conventional way to represent geophysical data. Conventional methods limit how geophysical data is processed since the information about the recording is not housed in one data format. Knowledge graphs can represent the entire recorded data and hence make processing substantially better as higher order dependencies between receivers or recording locations (e.g., nodes in graph terminology) can be captured easier. Knowledge graphs provide a framework to naturally store the data and make processing or analyzing of the data more robust.

The disclosed graph-based process can link subsurface information with a geological knowledge database, e.g. Neftex® software application (a proprietary data source) or other proprietary data sources, and with well data. The subsurface information includes geophysical data, petrophysical data, geological data, or a combination thereof. Seismic data is used herein as an example of the subsurface information. In some aspects, the process can include graph neural networks or transformers to create connections between, for example, seismic information and geologic features. For example, the process can build a machine learning model to link the context of depositional environment, structural regime, or proprietary data source petroleum system in a geologic story from a report with related seismic images. This can assist the machine learning model to recognize geological information from seismic data, as a first step (e.g., big picture) of the cognitive geology. Proprietary data sources can represent a proprietary knowledge system of data.

In some aspects, the processes can build another machine learning model to connect geologic labels or knowledge graphs with seismic images (e.g., sequence stratigraphy, seismic stratigraphy, Monte-Carlo (MC) pseudo wells from sequence stratigraphy knowledge graphs with seismic impedance, reservoir models with dip spread, or geological element spread functions) in latent space using a generative model. In some aspects, a vision-language learning system can be used to extract subsurface images as training data, for example, using a foundation-model system. In some aspects, the subsurface images can include geoscience text. The geoscience text can be integrated with the subsurface images, such as part of geoscience data. The process can include using a vision language system to extract the subsurface knowledge text (in this aspect, the geoscience text) and the subsurface images from the geoscience data and relate the extracted subsurface knowledge text and the subsurface images. In some aspects, synthetic data can be generated using the geoscience knowledge system correlated with the geoscience text and subsurface information.

In some aspects, the learning network can use reinforcement learning. After training, this generative model can understand and learn the features such as fault, salts, channels, or karsts to perform an unsupervised classification of seismic data. In some aspects, the relating can include generating a dictionary that relates the seismic images to the vectorized, e.g., tokenized, words. In some aspects, the relating includes using a learning network to learn mapping between the subsurface images and the vectorized words. In some aspects, the relating includes updating the dictionary or the mapping.

In some aspects, an inverse problem for estimating rock properties can be solved using subsurface information and a graph connection with a proprietary data source to generate amplitude variation with offset scenarios. In some aspects, subsurface knowledge (and associated uncertainties) can be inferred and subsequently be used to update subsurface knowledge. In some aspects, the subsurface knowledge can be used for well operations, for example, locating a well or modifying drilling operations for a well.

In some aspects, seismic data from a subterranean formation can be acquired using a seismic acquisition system. The acquisition process can include determining operating parameters for the seismic acquisition system based on synthetic geophysical data, configuring the seismic acquisition system according to the operating parameters, and acquiring the seismic data from the subterranean formation using the seismic acquisition system that is configured according to the operating parameters. In some aspects, at least some of the synthetic geophysical data corresponds to the subterranean formation. In some aspects, determining the operating parameters includes optimizing acquisition of the synthetic geophysical data using reinforcement learning. In some aspects, a graph representation of the synthetic geophysical data can be obtained and the operating parameters based on the graph representation of the synthetic geophysical data can be determined. In some aspects, the synthetic geophysical data can be generated using a cognitive geology learning system that can link geological information with seismic data. In some aspects, the cognitive geology learning system can link the geological information with the seismic data.

In some aspects, a process can be used to determine rock properties of a subterranean formation. In some aspects, the process can include acquiring seismic data of the subterranean formation, creating a graph representation of the seismic data, and providing a graphical representation of rock properties of the subterranean formation utilizing the seismic data graph representation. In some aspects, creating the seismic data graph representation includes using synthetic geological data for processing the seismic data. In some aspects, processing the seismic data graph representation can use a learning network. In some aspects, the learning network can be a graph neural network.

In one aspect, a method of inferring subsurface knowledge is disclosed. In one embodiment, the method includes (1) obtaining a geoscience knowledge system, obtaining subsurface information at a subterranean location, and (2) inferring subsurface knowledge of the subterranean location from the subsurface information using the geoscience knowledge system, wherein the subsurface knowledge is utilized to calculate an economic model parameter for a well system proximate the subterranean location.

In a second aspect, a computing system is disclosed. In one embodiment, the computing system includes (1) a data receiver, capable of receiving input parameters, a geoscience knowledge system, and subsurface information, where the subsurface information is at a subterranean location, and (2) one or more processors to perform operations, wherein the operations include communicating with the data receiver, and inferring subsurface knowledge of the subterranean location using the subsurface information processed using the geoscience knowledge system, where the subsurface knowledge is utilized to calculate an economic model parameter for a well system proximate the subterranean location.

In a third aspect, a computer program product having a series of operating instructions stored on a non-transitory computer-readable medium that directs a data processing apparatus when executed thereby to perform operations to infer subsurface knowledge is disclosed. In one embodiment, the operations include (1) obtaining a geoscience knowledge system, obtaining subsurface information at a subterranean location, and (2) inferring the subsurface knowledge of the subterranean location from the subsurface information using the geoscience knowledge system, wherein the subsurface knowledge is utilized to calculate an economic model parameter for a well system proximate the subterranean location.

Turning now to the figures, FIG. 1 is an illustration of an example well system 100, for example, a logging while drilling system, a measuring while drilling system, a seismic while drilling system, a telemetry while drilling system, injection well system, extraction well system, and other borehole systems. Well system 100 includes a derrick 120, a well site controller 130, and a computing system 135. Well site controller 130 includes a processor and a memory and is configured to direct operation of well system 100. Derrick 120 is located at a surface 101.

Extending below derrick 120 is a borehole 110. Borehole 110 is surrounded by subterranean formation 103. Surface sensors can be part of derrick 120. Surface sensors can be located at surface 101, such as seismic sensors 107 and gravimetric sensors 109.

Well site controller 130 or computing system 135 (e.g., surface controllers) which can be communicatively coupled to well site controller 130, can be utilized to communicate with seismic sensors 107, gravimetric sensors 109, or sensors located downhole borehole 110. Computing system 135 can be proximate well site controller 130 or be a distance away, such as in a cloud environment, a data center, a lab, or a corporate office or environment. Computing system 135 can be a laptop, smartphone, PDA, server, desktop computer, cloud computing system, other computing systems, or a combination thereof, that are operable to perform the processes described herein.

Well site operators, engineers, and other personnel can send and receive data, instructions, measurements, and other information by various conventional means, now known or later developed, with computing system 135 or well site controller 130. Well site controller 130 or computing system 135 can communicate with one or more of the various sensor types using conventional means, now known or later developed.

Seismic sensors 107, gravimetric sensors 109, downhole sensors, other types of sensors, or a combination of sensors can be used to collect subsurface information that can be used as input parameters into a subsurface knowledge system, such as subsurface knowledge system 800 of FIG. 8 or subsurface knowledge controller 900 of FIG. 9. The subsurface information, for example can capture the change in subterranean formation characteristics revealing the potential for hydrocarbon reservoirs 105. The input parameters can be used to infer subsurface knowledge using a geoscience knowledge system that can be communicated along with a confidence parameter. The subsurface knowledge and associated confidence parameter can be used as inputs to an economic modeling system to determine an economic model parameter, such as the relative values of a variety of potential tasks that could be conducted at well system 100.

In some aspects, the subsurface information can be communicated to another system, such as computer system 135 or well site controller 130. In some aspects, computing system 135 can be the subsurface knowledge system and can receive the input parameters. In some aspects, well site controller 130 can be the subsurface knowledge system and can receive the input parameters. In some aspects, the subsurface knowledge system can be partially included with well site controller 130 and partially located with computing system 135. In some aspects, the subsurface knowledge system can be located in another system, for example, a data center, a lab, a corporate office, or another location. In some aspects, the subsurface knowledge system can be located with downhole tools, such as with a geo-steering system, and the results of the analysis communicated to a downhole or surface system.

FIG. 1 depicts onshore operations. Those skilled in the art will understand that the disclosure is equally well suited for use in offshore operations. FIG. 1 depicts specific borehole configurations, those skilled in the art will understand that the disclosure is equally well suited for use in boreholes having other orientations including vertical boreholes, horizontal boreholes, slanted boreholes, multilateral boreholes, and other borehole types.

FIG. 2 is an illustration of an example subsurface formation 200 that can be collected via seismic imaging. In some aspects, subsurface formation 200 can be collected by one or more sensors, for example, seismic sensors. In some aspects, subsurface formation 200 can be received as synthetic data, such as from a lab, test data, training data, data collected from other subterranean formations or locations, or other data sources.

Subsurface formation 200 shows multiple rock layers. Rock layer 210 is the top layer. Rock layer 220 is the middle layer. Rock layer 230 is the bottom layer. Subsurface formation 200 can be used to obtain the subsurface information that is suitable for use with the selected machine learning system. For example, a vision-language learning system can be used to transform subsurface formation 200 to data, text, graph data, or network nodes.

FIG. 3 is an illustration of a diagram of an example process 300 to obtain subsurface information. Process 300 is a demonstration of one aspect showing an example functional view of the disclosed processes. Process 300 starts with a collection of subsurface information at a process point 310. Process point 310 shows a drilling rig at a surface location with rock strata shown underneath. A borehole is shown extending down from the drilling rig. Three subterranean locations are identified where seismic data is being collected. The analysis using the disclosed processes can be applied to each of these subterranean locations to determine the subsurface knowledge at each of these subterranean locations.

Process point 320 shows one sample of seismic imaging data from one of the subterranean locations. Process point 330 shows the sample from process point 320 after a denoise algorithm has been applied. Other transformation or processing algorithms can be applied as well, such as an inversion algorithm, or an algorithmic algorithm, such as an averaging, a smoothing, a contrast change, or other types of algorithms. Process point 340 shows the sample from process point 330 being transformed or converted to a format suitable for use by a machine learning algorithm, i.e., machine learning system.

Process point 350 shows four potential output types. Additional output types can be used as well, the four presented are for demonstration purposes. Output type 360 is the subsurface information organized such that a visual graph could be generated, shown as p-wave slowness at various depths of the seismic data. Output type 362 is tokenized representation, a data representation, or a text representation. Output type 364 is a network node representation. Output type 366 is an image representation. One or more of output types 360, 362, 364, or 366 can be used as part of the subsurface information used with the geoscience knowledge system (for example, the geoscience knowledge system shown in FIG. 4) to infer subsurface knowledge.

FIG. 4 is an illustration of an example artificial intelligence (AI) system 400 used to infer the subsurface knowledge. Artificial intelligence systems, e.g., machine learning models, can utilize various algorithms, such as ChatGPT, or other learning models, neural networks, or deep learning algorithms. The disclosed processes can utilize general public knowledge as a base for the geoscience knowledge system and for publicly available subsurface information. Industry and proprietary subsurface information can be included in the machine learning model.

For example in using an artificial intelligence system, like a ChatGPT, can be in asking a question such as whether one type of subterranean location can be used as an analogue to a second type of subterranean location. The system can return an answer such as the two subterranean locations are not necessarily a direct analogue. A generated corrected answer can be that the first subterranean location could potentially serve as an analogue to the second subterranean location.

The geoscience knowledge system can be a machine learning system that utilizes one or more reinforcement learning algorithms, meta-learning algorithms, NLP algorithms, or active learning algorithms.

The machine learning model can be applied to a task under consideration to evaluate the benefit of the task. Interpreting the subsurface information can involve analyzing the collected information to identify subsurface fractures, for example, faults, rock layers, or hydrocarbon distributions. The analyzing can include correlating the subsurface information to well logs, surface geology, and other information. Structural interpretation can be used to identify and map subsurface features, such as faults, folds, and rock layers, using the correlated subsurface information. Stratigraphic interpretation can be used to identify and map subsurface layers of rock, including the thickness and distribution of differing rock types. Reservoir interpretation can be used to identify and map subsurface hydrocarbon distributions, including the thickness and distribution of the reservoir rocks. Integration can combine the structural, stratigraphic, and reservoir information to generate a combined subsurface model for further analysis. The machine learning model can be continuously updated as new information is learned, such as from well logs, or collected sensor data.

AI system 400 has a system of network nodes 410 of organized data. Network nodes 410 can be used as the geoscience knowledge system. The network nodes 410 can be the machine learning algorithm that is used to infer the subsurface knowledge using received subsurface information.

A top portion 420 includes data and network connections that can be sourced from general public knowledge, such as from publicly available data sources, AI systems, government data sources, and other sources of the data. A middle portion 430 can include data and network connections sourced from industry specific data sources or from proprietary data sources, such as an internal database or a paid for service data source. A bottom portion 440 can include data and network connections sourced for a specific task that is being evaluated or analyzed by the subsurface knowledge system. Top portion 420, middle portion 430, and bottom portion 440 are shown as representative samples and each portion can contain fewer or greater number of nodes.

FIG. 5 is an illustration of a flow diagram of an example process 500 of inferring subsurface knowledge. Process 500 describes an example functional overview of the disclosed processes. In a function 510, the subsurface information can be received, such as from a database, data store, well logs, synthetic data source, reservoir sensors, or other sources. The subsurface information can be represented numerically, categorically, geologically, or associated to well or task specific characteristics.

In a function 520, the subsurface information can be transformed into a format suitable for a machine learning system, for example, a machine learning graph, a tokenized or textual representation, a network of nodes, or other machine learning formats. In a function 530, the subsurface information (for example, represented by a graph) can be used with a machine learning system, such as a geoscience knowledge system, to infer subsurface knowledge. The inference can be general, for example, general knowledge of the subterranean formation, or it can be task specific, for example, the economic benefit of drilling through a specific location.

In a function 540, the subsurface information can be embedded in a reduce space format, for example, a graph neural network (GNN). In a function 550, the embedded information can be used as input into various types of machine learning algorithms, for example, a vision-learning system or a NLP model (such as transforms, ChatGPT, Bard, Dall-E, and other models). The embedded information can be used to fine tune the output of the machine learning algorithms or to replace image embedding.

FIG. 6 is an illustration of a flow diagram of an example method 600 to infer subsurface knowledge. Method 600 can be performed on a computing system, for example, subsurface knowledge system 800 of FIG. 8 or subsurface knowledge controller 900 of FIG. 9. The computing system can be a reservoir controller, a well site controller, a geo-steering system, a data center, a cloud environment, a server, a laptop, a mobile device, smartphone, PDA, or other computing system capable of receiving the subsurface information, input parameters, geoscience knowledge system, and capable of communicating with other computing systems. Method 600 can be encapsulated in software code or in hardware, for example, an application, code library, dynamic link library, module, function, RAM, ROM, and other software and hardware implementations. The software can be stored in a file, database, or other computing system storage mechanism. Method 600 can be partially implemented in software and partially in hardware. Method 600 can perform the steps for the described processes, for example, inferring subsurface knowledge from the input sources.

Method 600 starts at a step 605 and proceeds to a step 610. In step 610, a geoscience knowledge system is obtained, received, or identified for use. The geoscience knowledge system can be one or more of various types of machine learning algorithms or models. In some aspects, the geoscience knowledge system can be partially or wholly sourced from publicly available information, for example, ChatGPT, bard, government databases, or other sources. In some aspects, the geoscience knowledge system can be sourced from industry specific or proprietary data sources, for example, a geological log or a corporate database. In some aspects, the geoscience knowledge system can be sourced from task specific data sources, such as well logs, sensor data, or other data sources. In some aspects, a combination of two or more of these data sources types can be used. The geoscience knowledge system can be represented using various techniques, such as graphs, graph data, network nodes, ordered images, tokenized or textualized data, or other representations.

In a step 615, subsurface information can be obtained, received, or identified for use. In some aspects, the subsurface information can be collected from sensors, for example, downhole sensors or surface sensors. The sensors can be various types of sensors, such as seismic sensors, acoustic sensors, gravimetric sensors, nuclear magnetic resonance sensors, electrical sensors, or other sensor types. In some aspects, the subsurface information can be received from previously collected sensor data, for example, well logs, reservoir logs, corporate data sources, borehole sensors located proximate or distant from the subterranean formation of interest, or other data sources. In some aspects, the subsurface information can be identified as synthetic information, for example, default values, previously modeled subterranean information, test data, sample data, lab data, a corporate environment, or other data sources that are synthetic to the subterranean formation of interest.

Subsurface information can include prior subsurface knowledge, such as geology knowledge graphs, probability maps for exploration, proprietary data sources, deep reinforcement learning models for cognitive assistant for worldwide depositional environments, analogs, play concepts, and other sources.

Subsurface information can be data representing the rock layers, faults, fractures, cavities, reservoirs, boreholes, or other subterranean formation information. For example, a seismic image capturing a fold in several rock layers can be subsurface information. The subsurface information typically represents the physical attributes or characteristics of the subterranean formation of interest. In some aspects, the subsurface information can be transformed into a format suitable for use by a machine learning system. For example, the subsurface information can be transformed into a graph, graph data, network nodes, image data, tokenized data, textualized data, or other suitable formats.

In a step 620, the subsurface information as transformed in step 615 can be used with the geoscience knowledge system from step 610 to infer subsurface knowledge. Subsurface knowledge can be the extension of the subsurface information to arrive at estimations, approximations, or conclusions about the subterranean formation of interest. For example, the subsurface information can specify a type of combination of rock layers and with the geoscience knowledge system, an inference can be made that there is a high likelihood of a hydrocarbon reservoir nearby. The high likelihood of a hydrocarbon reservoir nearby can be the subsurface knowledge.

In a step 625, the subsurface knowledge from step 620 can be used in further systems or calculations. For example, the subsurface knowledge can be used to calculate an economic model parameter for performing a task proximate the subterranean formation of interest. The task can be, for example, locating a well system at a surface location, altering a borehole path, drilling an avoidance well or an interception well, determining where hydraulic fracturing should occur, or various other types of industrial, hydrocarbon, or scientific tasks. Method 600 ends at a step 695.

FIG. 7A is an illustration of a flow diagram of an example method 700 using seismic imaging to infer subsurface knowledge. Method 700 can be performed on a computing system, for example, subsurface knowledge system 800 of FIG. 8 or subsurface knowledge controller 900 of FIG. 9. The computing system can be a well site controller, a geo-steering system, a reservoir controller, a data center, a cloud environment, a server, a laptop, a mobile device, smartphone, PDA, or other computing system capable of receiving the acoustic data, input parameters, and capable of communicating with other computing systems. Method 700 can be encapsulated in software code or in hardware, for example, an application, code library, dynamic link library, module, function, RAM, ROM, and other software and hardware implementations. The software can be stored in a file, database, or other computing system storage mechanism. Method 700 can be partially implemented in software and partially in hardware. Method 700 can perform the steps for the described processes, for example, determining the potential for an event using a weighted analysis of data collected from more than one type of sensor.

In some aspects, method 700 can be used to optimize acquisition of seismic data based on synthetic geophysical data, which can be represented on a graph. The optimization can include determining operating parameters for optimizing acquisition of the synthetic geophysical data using a subsurface learning system. The subsurface learning system can be a machine learning system that uses one or more of reinforcement learning, meta-learning, NLP, or active learning. The subsurface learning system can use a model trained to optimize cost and effectiveness of the seismic acquisition system. Using the determined operating parameters, the seismic data can be acquired, presented in one or more graphs, processed, and used to infer subsurface knowledge. For example, subsurface knowledge can be updated using seismic data (e.g. using Bayes rule for conditional probabilities, calculate posterior subsurface distribution, or update the graph in Q-matrix of a reinforcement learning model). Decision analysis under uncertainty and using incomplete data (e.g. decision trees or agent in Markov's reinforcement learning) can be used as well.

In some aspects, seismic data can be received and a graph representation of the seismic data can be generated. In some aspects, graphs for geology, wells, or other data points can be added. Using seismic graph and the optional graphs, a graph of Earth properties can be generated. In some aspects, the inverse problem for the graphs can be resolved, such as with quantification of resulting (posterior) uncertainties for estimates of parameters of subsurface. In some aspects, the output results can be used for optimization for field development planning. In some aspects, the output results can be used to calculate economic model parameters, such as reserves, production potential, and other economic criteria. In some aspects, the output results can be used to make decisions on investing in energy projects or to execute other well operations or tasks.

Method 700 starts at a step 705 and proceeds to a step 710. In step 710, seismic data (raw subsurface information) can be obtained, such as from seismic sensors located at a surface location of a reservoir, or from downhole sensors that are located downhole a borehole. In a step 715, the seismic data can be used to generate a seismic image (partially processed subsurface information). In a step 720, the seismic image can be used to create one or more synthetic images (processed subsurface information), for example, denoising the seismic image, applying an inversion algorithm, or applying an algorithmic algorithm (such as smoothing, averaging, removing outlier data points, or other algorithm types). In some aspects, vision-learning systems can be used to process the seismic images.

In a step 725, rock properties, i.e., subterranean formation characteristics, can be determined using the synthetic images, i.e., the processed subsurface information, and the seismic images. In some aspects, a machine learning system can be applied to the seismic and synthetic images to infer the rock properties. In a step 730, an economic model parameter can be determined using the rock properties. For example, a hydrocarbon distribution in the subterranean formation can be determined using the rock properties. The hydrocarbon distribution can then be utilized to drive decision making on whether that subterranean formation location should be further developed, maintained, or abandoned.

In a step 735, the economic model parameter, for example, a hydrocarbon distribution, can be used to determine the next steps or operations to be taken. For example, a decision can be made on where to locate a future well system, the direction of future drilling of an existing borehole, where hydraulic fracturing should take place and under what intensity. Equipment decisions can also be made, for example, the type of casing used can be changed, the type of drill bit can be changed to improve drilling efficiency, the mixture of the drilling fluid can be modified (for example, adding or subtracting chemical additives, solids, or other material), and other equipment decisions. Method 700 ends at a step 795.

FIG. 7B is an illustration of a flow diagram of an example method 750 for economic analysis. Method 750 can be performed on a computing system, for example, subsurface knowledge system 800 of FIG. 8 or subsurface knowledge controller 900 of FIG. 9. The computing system can be a well site controller, a geo-steering system, a reservoir controller, a data center, a cloud environment, a server, a laptop, a mobile device, smartphone, PDA, or other computing system capable of receiving the acoustic data, input parameters, and capable of communicating with other computing systems. Method 750 can be encapsulated in software code or in hardware, for example, an application, code library, dynamic link library, module, function, RAM, ROM, and other software and hardware implementations. The software can be stored in a file, database, or other computing system storage mechanism. Method 750 can be partially implemented in software and partially in hardware. Method 750 can perform the steps for the described processes, for example, determining the potential for an event using a weighted analysis of data collected from more than one type of sensor.

Method 750 starts at a step 755 and proceeds to a step 760. In step 760, an input can be received that includes an economic model. The economic model can have uncertain or unknown parameters related to subsurface uncertainties, for example, uncertainty around a recoverable hydrocarbon reserve.

In an optional step 765, the unknown parameters can be analyzed as to their sensitivity to the available data. In some aspects, the available data can be, for example, the seismic data or other sensor data. In some aspects, the sensitivity analysis can relate to the knowledge of the subsurface, e.g., subterranean formation location (geological data).

In a step 770, the uncertainty of the unknown parameters can be assessed given the available data or knowledge. This step can incorporate, for example, method 600 or method 700, where the subsurface knowledge is inferred from the subsurface information and geoscience knowledge system. In a step 775, an economic analysis can be performed using the uncertainty estimates of the unknown parameters.

In an optional step 780, new data can be designed, acquired, or processed to reduce the uncertainty of the unknown parameters. In a step 785, the economic decisions can be output, such as a well placement, a drilling path direction, investment in a major capital project, or other economic model parameter. Method 750 ends at step 795.

FIG. 8 is an illustration of a block diagram of an example subsurface knowledge system 800, which can be implemented in one or more computing systems, for example, a data center, cloud environment, server, laptop, smartphone, tablet, and other computing systems. In some aspects, subsurface knowledge system 800 can be implemented using a subsurface knowledge controller such as subsurface knowledge controller 900 of FIG. 9. Subsurface knowledge system 800 can implement one or more methods of this disclosure, such as method 600 of FIG. 6, method 700 of FIG. 7A, or method 750 of FIG. 7B.

Subsurface knowledge system 800, or a portion thereof, can be implemented as an application, a code library, a dynamic link library, a function, a module, other software implementation, or combinations thereof. In some aspects, subsurface knowledge system 800 can be implemented in hardware, such as a ROM, a graphics processing unit, or other hardware implementation. In some aspects, subsurface knowledge system 800 can be implemented partially as a software application and partially as a hardware implementation. Subsurface knowledge system 800 is a functional view of the disclosed processes and an implementation can combine or separate the described functions in one or more software or hardware systems.

Subsurface knowledge system 800 includes a data transceiver 810, a subsurface knowledge processor 820, and a result transceiver 830. The results, (e.g., the subsurface knowledge), analysis, and interim outputs from subsurface knowledge processor 820 can be communicated to a data receiver, such as a reservoir controller 860, a computing system 862, other processing or storage systems 864, or one or more of a user or user system 866. Computing system 862 can be a well site controller, a well planner, a corporate computing system, or other computing systems. The results can be used to determine the economic model parameters of selected tasks, for example, directions provided to a drilling system or used as inputs into a well site controller or other borehole system, such as a drilling operation planning system.

Data transceiver 810 can receive input parameters, such as user parameters to direct the operation of the analysis implemented by subsurface knowledge processor 820, such as machine learning models to utilize, algorithmic processing algorithms to utilize, or other parameters in determining the results, a geoscience knowledge system to utilize, subsurface information, or other input parameters. In some aspects, data transceiver 810 can be part of subsurface knowledge processor 820.

Result transceiver 830 can communicate one or more results, analysis, or interim outputs, to one or more data receivers, such as a reservoir controller 860, a computing system 862, storage system 864, e.g., a data store or database, a user or user system 866, or other related systems, whether located proximate result transceiver 830 or distant from result transceiver 830. Data transceiver 810, subsurface knowledge processor 820, and result transceiver 830 can be, or can include, conventional interfaces configured for transmitting and receiving data.

Subsurface knowledge processor 820 (e.g., processor 912 of FIG. 9) can implement the analysis and algorithms as described herein utilizing the input parameters, the geoscience knowledge system, the subsurface information, and other received parameters. In some aspects, subsurface knowledge processor 820 can be a machine learning system, such as to infer subsurface knowledge from the received subsurface information and geoscience knowledge system. In some aspects, subsurface knowledge processor 820 can perform pre-processing on the subsurface information, such as to transform the information to a format suitable for use with the machine learning system. This can include denoising the data or transforming the data to an alternate format. Subsurface knowledge processor 820 can be implemented in a corporate system, a lab environment, a data center, an edge computing system, a cloud environment, a reservoir controller, a well site controller, a drilling controller, or other surface controller or downhole controller.

A memory or data storage of subsurface knowledge processor 820 can be configured to store the processes and algorithms for directing the operation of subsurface knowledge processor 820. Subsurface knowledge processor 820 can also include a processor that is configured to operate according to the analysis operations and algorithms disclosed herein, and an interface to communicate (transmit and receive) data. Subsurface knowledge processor 820 can be one or more processors or computing systems.

FIG. 9 is an illustration of a block diagram of an example of a subsurface knowledge controller 900 according to the principles of the disclosure. Subsurface knowledge controller 900 can be stored on a single computer or on multiple computers. The various components of subsurface knowledge controller 900 can communicate via wireless or wired conventional connections. A portion or a whole of subsurface knowledge controller 900 can be located at one or more locations and other portions of subsurface knowledge controller 900 can be located on a computing device or devices at a distant location. In some aspects, subsurface knowledge controller 900 can be wholly located at a surface or distant location. In some aspects, subsurface knowledge controller 900 can be part of another system, and can be integrated in a single device, such as a part of a corporate system, a data center, a could environment, an edge computing system, a lab computing system, a reservoir controller, a drilling operation planning system, a well site controller, or other borehole system.

Subsurface knowledge controller 900 can be configured to perform the various functions disclosed herein including receiving input parameters, a geoscience knowledge system, subsurface information, and other input data and parameters, and generating results from an execution of the methods and processes described herein, such as inferring subsurface knowledge, calculating an economic model parameter, determining a hydrocarbon distribution, and other results and analysis. Subsurface knowledge controller 900 includes a hydrocarbon locator 910, a communications interface 914, a memory 916, and a processor 912.

Communications interface 914 is configured to transmit and receive data. For example, communications interface 914 can receive the input parameters, user parameters, geoscience knowledge system, subsurface information, and other data or parameters. Communications interface 914 can transmit the results or interim outputs. In some aspects, communications interface 914 can transmit a status, such as a success or failure indicator of subsurface knowledge controller 900 regarding receiving the various inputs, transmitting the generated results, or producing the results. Communications interface 914 can communicate the subsurface knowledge (e.g., rock properties) to another system 920, such as a reservoir controller or a well operations controller.

In some aspects, a machine learning system can be implemented by processor 912 and perform the operations as described by subsurface knowledge processor 820. Communications interface 914 can communicate via communication systems used in the industry. For example, wireless or wired protocols can be used. Communication interface 914 is capable of performing the operations as described for data transceiver 810 and result transceiver 830 of FIG. 8.

Memory 916 can be configured to store a series of operating instructions that direct the operation of processor 912 when initiated, including the code representing the algorithms for determining processing the collected data. Memory 916 is a non-transitory computer readable medium. Multiple types of memory can be used for data storage and memory 916 can be distributed.

Processor 912 can be configured to produce the results (e.g., determining the potential for an event occurring, and other results), one or more interim outputs, and statuses utilizing the received inputs. Processor 912 can be configured to direct the operation of subsurface knowledge controller 900. Processor 912 includes the logic to communicate with communications interface 914 and memory 916, and perform the functions described herein. Processor 912 is capable of performing or directing the operations as described by subsurface knowledge processor 820 of FIG. 8.

Various figures and descriptions can demonstrate a visual display of the input parameters and the resulting analysis of the input parameters. In some aspects, the visual display can be utilized by a user to determine the next steps of the analysis. In some aspects, the visual display does not need to be generated, and a system, such as a machine learning system, can perform the analysis using the input parameters. In some aspects, a visual display and a machine learning system can be utilized. In some aspects, the input parameters or partially analyzed input parameters can be transmitted to one or more surface computing systems or downhole computing systems, such as a well site controller, a computing system, or other processing system. The surface system or downhole system can perform the analysis and can communicate the results to one or more other systems, such as a well site controller, a well site operation planner, a geo-steering system, or another borehole system.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic and/or features for performing a task or tasks. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein. Aspects disclosed herein include:

A. A method of inferring subsurface knowledge including (1) obtaining a geoscience knowledge system, obtaining subsurface information at a subterranean location, and (2) inferring subsurface knowledge of the subterranean location from the subsurface information using the geoscience knowledge system, wherein the subsurface knowledge is utilized to calculate an economic model parameter for a well system proximate the subterranean location.

B. A computing system including (1) a data receiver, capable of receiving input parameters, a geoscience knowledge system, and subsurface information, where the subsurface information is at a subterranean location, and (2) one or more processors to perform operations, wherein the operations include communicating with the data receiver, and inferring subsurface knowledge of the subterranean location using the subsurface information processed using the geoscience knowledge system, where the subsurface knowledge is utilized to calculate an economic model parameter for a well system proximate the subterranean location.

C. A computer program product having a series of operating instructions stored on a non-transitory computer-readable medium that directs a data processing apparatus when executed thereby to perform operations, the operations include (1) obtaining a geoscience knowledge system, obtaining subsurface information at a subterranean location, and (2) inferring the subsurface knowledge of the subterranean location from the subsurface information using the geoscience knowledge system, wherein the subsurface knowledge is utilized to calculate an economic model parameter for a well system proximate the subterranean location.

Each of the aspects disclosed in A, B, and C above can have one or more of the following additional elements in combination. Element 1: wherein the subsurface knowledge is a hydrocarbon distribution. Element 2: wherein the subsurface knowledge is geophysical data. Element 3: wherein the geophysical data is one or more of a seismic data or a fossil information. Element 4: wherein the subsurface knowledge is utilized to direct a well operation at a well site. Element 5: wherein the subsurface knowledge is represented by graph data. Element 6: wherein the subsurface information is denoised prior to being used for the inferring. Element 7: wherein the subsurface knowledge is represented by a machine learning algorithm. Element 8: wherein the geoscience knowledge system is trained using a geoscience learning system. Element 9: where the geoscience learning system comprises acquiring subsurface knowledge text. Element 10: where the geoscience learning system comprises acquiring subsurface information. Element 11: where the geoscience learning system comprises correlating the subsurface knowledge text and the subsurface information. Element 12: where the geoscience learning system comprises training the geoscience knowledge system to identify hydrocarbon distributions utilizing the correlating. Element 13: wherein geoscience text is integrated with subsurface images in geoscience data, and the acquiring and the correlating includes using a vision language system to extract the subsurface knowledge text and the subsurface images from the geoscience data and relate respective of the extracted subsurface knowledge text and the subsurface images. Element 14: further comprising tokenizing the subsurface knowledge text. Element 15: further comprising creating training labels from the tokenized subsurface knowledge text. Element 16: wherein the training includes using the tokenized subsurface knowledge text as the training labels and the extracted subsurface images as training data. Element 17: wherein the training includes using the tokenized subsurface knowledge text as the training data and the extracted subsurface images as the training labels. Element 18: wherein the subsurface images are received using a vision-language learning system. Element 19: wherein the subsurface images are seismic images. Element 20: wherein the subsurface information includes subsurface raw data and subsurface processed data. Element 21: wherein the acquiring the subsurface knowledge text includes using a NLP learning system to capture the subsurface knowledge text from geoscience data. Element 22: wherein the acquiring the subsurface knowledge text includes using a NLP learning system to convert the subsurface knowledge text to machine processable data Element 23: wherein the acquiring the subsurface knowledge text includes using a NLP learning system to vectorize the machine processable data to use as training labels for the training. Element 24: wherein the training includes using the machine processable data as the training labels and the subsurface images as training data. Element 25: wherein the training includes using the subsurface images as the training labels and the machine processable data as the training data. Element 26: wherein the subsurface knowledge text and subsurface images are acquired from one or more of a geoscience knowledge database, a geoscience document, or a geoscience article. Element 27: wherein the subsurface information is received from well log data. Element 28: wherein the subsurface knowledge represents a spatial and a depth information. Element 29: wherein the subsurface knowledge represents a spatial and a geologic time information of subterranean formations. Element 30: wherein the geoscience knowledge system is a machine learning system using one or more of a reinforcement learning algorithm, a meta-learning algorithm, a NLP algorithm, or an active learning algorithm. Element 31: wherein the subsurface information is at least partially synthetic data. Element 32: wherein the synthetic data is generated using the geoscience knowledge system correlated with geoscience text with the subsurface information. Element 33: further comprising a result transceiver, capable of communicating the subsurface knowledge to a well planning system, a reservoir planning system, or a user. Element 34: wherein the one or more processors utilize a machine learning system to infer the subsurface information using the geoscience knowledge system and the subsurface information. Element 35: wherein the machine learning system is trained using the subsurface information and a vision-language learning system. Element 36: wherein the machine learning system utilizes synthetic and non-synthetic subsurface information received from a database, a lab, a corporate environment, or well logs. Element 37: wherein the one or more processors are part of a reservoir controller.

What is claimed is:

1. A method of inferring subsurface knowledge, comprising:
obtaining a geoscience knowledge system;
obtaining subsurface information at a subterranean location; and
inferring subsurface knowledge of the subterranean location from the subsurface information using the geoscience knowledge system, wherein the subsurface knowledge is utilized to calculate an economic model parameter for a well system proximate the subterranean location.

2. The method as recited in claim 1, wherein the subsurface knowledge is a hydrocarbon distribution.

3. The method as recited in claim 1, wherein the subsurface knowledge is geophysical data.

4. The method as recited in claim 3, wherein the geophysical data is one or more of a seismic data or a fossil information.

5. The method as recited in claim 1, wherein the subsurface knowledge is utilized to direct a well operation at a well site.

6. The method as recited in claim 1, wherein the subsurface knowledge is represented by graph data.

7. The method as recited in claim 6, wherein the subsurface information is denoised prior to being used for the inferring.

8. The method as recited in claim 1, wherein the subsurface knowledge is represented by a machine learning algorithm.

9. The method as recited in claim 1, wherein the geoscience knowledge system is trained using a geoscience learning system, where the geoscience learning system comprises:
acquiring subsurface knowledge text;
acquiring subsurface information;
correlating the subsurface knowledge text and the subsurface information; and
training the geoscience knowledge system to identify hydrocarbon distributions utilizing the correlating.

10. The method as recited in claim 9, wherein geoscience text is integrated with subsurface images in geoscience data, and the acquiring and the correlating includes using a vision language system to extract the subsurface knowledge text and the subsurface images from the geoscience data and relate respective of the extracted subsurface knowledge text and the subsurface images.

11. The method as recited in claim 10, further comprising:
tokenizing the subsurface knowledge text; and
creating training labels from the tokenized subsurface knowledge text, wherein the training includes using the tokenized subsurface knowledge text as the training labels and the extracted subsurface images as training data or using the tokenized subsurface knowledge text as the training data and the extracted subsurface images as the training labels.

12. The method as recited in claim 10, wherein the subsurface images are received using a vision-language learning system.

13. The method as recited in claim 10, wherein the subsurface images are seismic images.

14. The method as recited in claim 9, wherein the subsurface information includes subsurface raw data and subsurface processed data.

15. The method as recited in claim 9, wherein the acquiring the subsurface knowledge text includes using a natural language processing (NLP) learning system to capture the subsurface knowledge text from geoscience data, convert the subsurface knowledge text to machine processable data, and vectorize the machine processable data to use as training labels for the training.

16. The method as recited in claim 15, wherein the training includes using the machine processable data as the training labels and the subsurface images as training data, or using the subsurface images as the training labels and the machine processable data as the training data.

17. The method as recited in claim 9, wherein the subsurface knowledge text and subsurface images are acquired from one or more of a geoscience knowledge database, a geoscience document, or a geoscience article.

18. The method as recited in claim 1, wherein the subsurface information is received from well log data.

19. The method as recited in claim 1, wherein the subsurface knowledge represents one or more of a spatial and a depth information, or the spatial and a geologic time information of subterranean formations.

20. The method as recited in claim 1, wherein the geoscience knowledge system is a machine learning system using one or more of a reinforcement learning algorithm, a meta-learning algorithm, a NLP algorithm, or an active learning algorithm.

21. The method as recited in claim 1, wherein the subsurface information is at least partially synthetic data.

22. The method as recited in claim 21, wherein the synthetic data is generated using the geoscience knowledge system correlated with geoscience text with the subsurface information.

23. A computing system, comprising:
a data receiver, capable of receiving input parameters, a geoscience knowledge system, and subsurface information, where the subsurface information is at a subterranean location; and
one or more processors to perform operations, wherein the operations include communicating with the data receiver, and inferring subsurface knowledge of the subterranean location using the subsurface information processed using the geoscience knowledge system, where the subsurface knowledge is utilized to calculate an economic model parameter for a well system proximate the subterranean location.

24. The computing system as recited in claim 23, further comprising:
a result transceiver, capable of communicating the subsurface knowledge to a well planning system, a reservoir planning system, or a user.

25. The computing system as recited in claim 23, wherein the one or more processors utilize a machine learning system to infer the subsurface information using the geoscience knowledge system and the subsurface information.

26. The computing system as recited in claim 25, wherein the machine learning system is trained using the subsurface information and a vision-language learning system.

27. The computing system as recited in claim 25, wherein the machine learning system utilizes synthetic and non-synthetic subsurface information received from a database, a lab, a corporate environment, or well logs.

28. The computing system as recited in claim 23, wherein the one or more processors are part of a reservoir controller.

29. A computer program product having a series of operating instructions stored on a non-transitory computer-readable medium that directs a data processing apparatus when executed thereby to perform operations to infer subsurface knowledge, the operations comprising:
obtaining a geoscience knowledge system;
obtaining subsurface information at a subterranean location; and
inferring the subsurface knowledge of the subterranean location from the subsurface information using the geoscience knowledge system, wherein the subsurface knowledge is utilized to calculate an economic model parameter for a well system proximate the subterranean location.
